(19) United States
(12) Patent Application Publication
(10) Pub. No.: US 2024/0238646 A1
(43) Pub. Date: Jul. 18, 2024

(54) TREADMILL, WAKEUP METHOD AND FALL DETECTION METHOD THEREOF

(71) Applicant: PIXART IMAGING INC., Hsin-Chu County (TW)

(72) Inventors: Ming Shun Manson FEI, Hsin-Chu County (TW); Sen-Huang HUANG, Hsin-Chu County (TW); Kai-Shun CHEN, Hsin-Chu County (TW); Ting-Yang CHANG, Hsin-Chu County (TW); Ren-Hau GU, Hsin-Chu County (TW); Yuan-Hsin LIAO, Hsin-Chu County (TW)

(21) Appl. No.: 18/323,480

(22) Filed: May 25, 2023

Related U.S. Application Data
(60) Provisional application No. 63/439,592, filed on Jan. 18, 2023.

(51) Int. Cl. A63B 24/00; A63B 22/02; G06V 10/22; G06V 40/16

(52) U.S. Cl. CPC A63B 24/0062; A63B 22/025; A63B 24/0087; G06V 10/22; G06V 40/161; A63B 2071/0081

(57) ABSTRACT

There is provided a treadmill capable of performing the fall detection. The treadmill includes a light sensor and a processor. The light sensor acquires an image frame toward an operation space. The processor performs the occupancy detection on the image frame using face detection and human detection. Upon not detecting the operation space being occupied by any user during a running state of the treadmill, the processor deactivates the treadmill and raises a fall alarm.

### CROSS-REFERENCE TO RELATED APPLICATIONS

The present application claims the priority benefit of U.S. Provisional Application Ser. No. 63/439,592, filed on Jan. 18, 2023, the disclosure of which is hereby incorporated by reference herein in its entirety.

### FIELD OF THE DISCLOSURE

This disclosure generally relates to a sports equipment and, more particularly, to a treadmill equipped with an optical sensing chip, and a wakeup method as well as a fall detection method thereof.

### BACKGROUND OF THE DISCLOSURE

Exercising in a gym becomes a trend for people living in cities since the gym has various kinds of sports equipment to train different muscles groups. In all the sports equipment, a treadmill is the most basic one. Not only almost every gym is equipped with treadmills, the treadmill is also suitable to be put at home for daily training.

However, because the treadmill itself has power, which is not automatically cut unless turned off manually, and if a user suddenly feels uncomfortable to be unable to follow a running speed of the treadmill, the user can fall while exercising on the treadmill to cause dangerous.

Accordingly, it is required to provide a treadmill having the fall detection function.

### SUMMARY

Accordingly, the present disclosure provides a treadmill that realizes the fall detection by arranging an optical sensing chip to detect whether an operation space is occupied by a user or not in a running state.

The present disclosure further provides a treadmill that detects whether an operation space is occupied by a user in an idle state so as to automatically activate a console while the operation space being occupied thereby improving the user experience.

The present disclosure further provides a treadmill that detects at least one of a step frequency and a weight of a user according to an optical method.

The present disclosure further provides a treadmill that detects and shows exercise performance according to a variation of moving speed of the tread belt.

The present disclosure provides a treadmill including a base, a console, a light sensor and a processor. The base is configured to determine an operation space of the treadmill. The console is configured to show operating information of the treadmill. The light sensor is configured to acquire an image frame toward the operation space using a field of view. The processor is configured to perform face detection and human detection on the image frame, and identify whether the operation space is occupied by any user according to detection results of the face detection and the human detection.

The present disclosure further provides a wakeup method of a treadmill, which includes a console, a base and an optical sensing chip. The wakeup method includes the steps of: entering an idle state; performing motion detection using the optical sensing chip; upon a motion being detected, performing occupancy detection of the base using the optical sensing chip; and upon detecting that the base is occupied by a user, waking up the console.

The present disclosure further provides an occupancy detection method of a treadmill including a console, a base and an optical sensing chip. The occupancy detection method includes the steps of: entering an operating state and performing occupancy detection of the base using the optical sensing chip; upon the base not being occupied by any user for a first time interval, controlling the console to raise a confirm message by the optical sensing chip; and upon the confirm message not being cancelled for a second time interval, leaving the operating state and raising an alarm.

### BRIEF DESCRIPTION OF DRAWINGS

Other objects, advantages, and novel features of the present disclosure will become more apparent from the following detailed description when taken in conjunction with the accompanying drawings.

FIG. 1 is a lateral view of an operating state of a treadmill according to one embodiment of the present disclosure.

FIG. 2 is a top view of an operating state of a treadmill according to one embodiment of the present disclosure.

FIG. 3 is a block diagram of a treadmill according to one embodiment of the present disclosure.

FIG. 4 is a flow chart of an auto-wakeup method of a treadmill according to one embodiment of the present disclosure.

FIG. 5 is a flow chart of a fall detection method of a treadmill according to one embodiment of the present disclosure.

FIG. 6 is a vertical view of an operating state of a treadmill according to another embodiment of the present disclosure.

FIG. 7 is a schematic diagram of detecting a user's weight with an optical method by a treadmill according to one embodiment of the present disclosure.

FIG. 8 is a schematic diagram of a variation of a belt speed of one step corresponding to different running postures of a user on a treadmill according to one embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a treadmill capable of automatically being woken up and performing fall detection by detecting whether an operation space thereof is occupied by a user. The present disclosure is to identify whether the operation space is occupied by the user according to the image frame(s) captured by a light sensor.

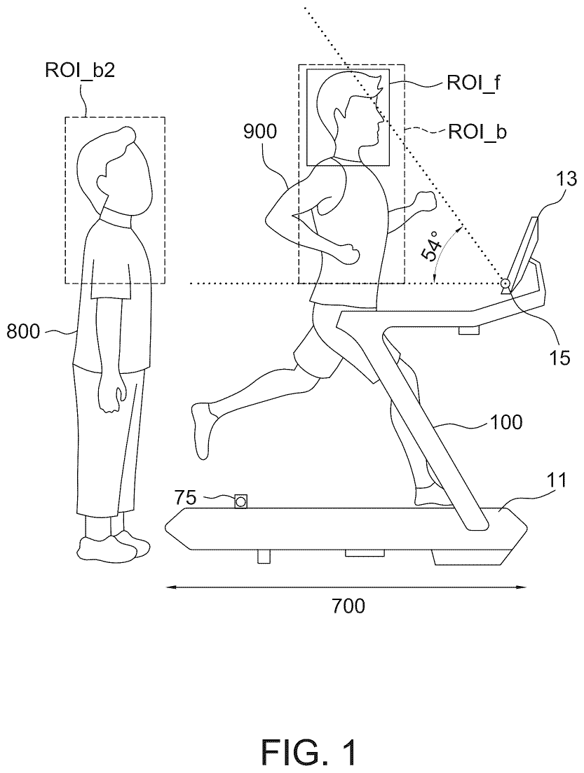

Please refer to FIG. 1, it is a lateral view of an operating state of a treadmill 100 according to one embodiment of the present disclosure. FIG. 1 shows a first user (e.g., valid user) 900 running on/occupying the treadmill 100, and a second user (e.g., invalid user) 800 standing behind the treadmill 100, not using the treadmill 100.

The treadmill 100 includes a base 11, a console 13 and an optical sensing chip 15. The base 11 and the console 13 are connected by a connecting rod, which is preferably embedded with the electric line(s) and the signal line(s) to electrically couple the base 11 and the console 13. The base 11 provides electricity to the console 13 via the electric line(s), and the console 13 provides control signals and detection signals to the base 11 via the signal line(s), wherein the shape and material of the connecting rod are not particularly limited as long as the console 13 is lifted up to a height which allows users to easily operate the console 13. The optical sensing chip 15 is arranged on or embedded in the console 13 without particular limitations. In another aspect, the optical sensing chip 15 is arranged on the connecting rod and electrically connected to the console 13.

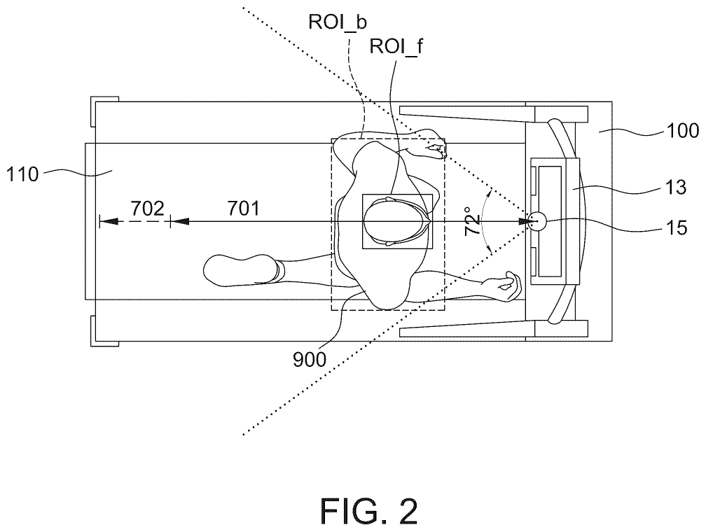

Please refer to FIG. 2 at the same time, it is a top view of an operating state of a treadmill 100 according to one embodiment of the present disclosure. The base 11 has a tread belt 110 which generally moves from a front of the treadmill 100 (i.e. right hand side in FIG. 2) to a rear of the treadmill 100 (i.e. left hand side in FIG. 2) with a controllable speed (e.g., controlled by the console 13) such that the user 900 walks or runs thereon. The base 11 (more specifically the tread belt 110) determines an operation space/range of the treadmill 100, e.g., shown as 700 in FIG. 1. FIG. 2 shows that a preferably operation space/range is 701, and a maximum operation space/range is 701+702 as an example.

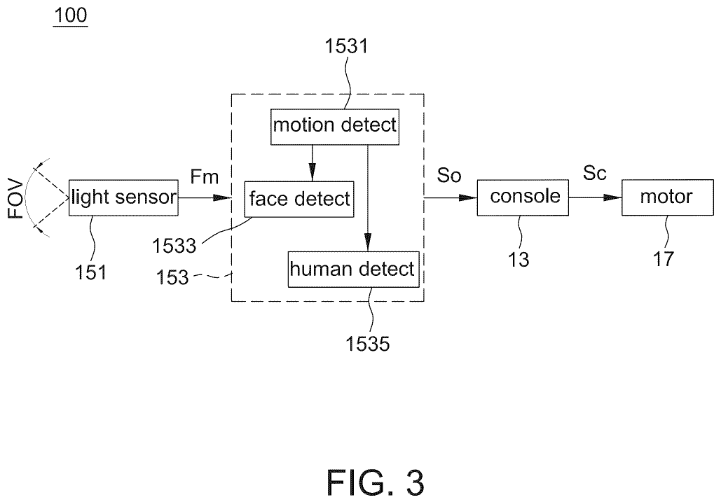

The console 13 includes a screen (e.g., a liquid crystal display, a plasma display, an OLED display, or a QLED display but not limited thereto) for showing operating information of the treadmill 100 and user information, e.g., including a speed, a tilted angle, an operating time interval of the tread belt 110, as well as a heartbeat, a step frequency and a weight of the user, but not limited thereto. The screen is used to show any predetermined information. In one aspect, the console 13 includes a touch control display to allow users to directly operate the console 13 through the touch control display. In another aspect, the console 13 includes a liquid crystal display and multiple keys and/or switches such that the users operate the console 13 through the multiple keys and/or switches. The console 13 controls (e.g., using control signal Sc) the motor(s) 17, e.g., referring to FIG. 3, in the base 11 to determine a moving speed of the tread belt 110 driven by the motor(s) 17.

FIG. 3 is a schematic block diagram of a treadmill 100 according to one embodiment of the present disclosure. In the present disclosure, the optical sensing chip 15 includes a light sensor 151 and a processor 153.

The light sensor 151 is, for example, a Complementary Metal-Oxide-Semiconductor (CMOS) image sensor, a Charge Coupled Device (CCD) image sensor or the like without particular limitations. The light sensor 151 has a field of view (FOV), e.g., FIG. 1 showing a longitudinal angle of the FOV is 54 degrees, and FIG. 2 showing a transverse angle of the FOV is 72 degrees, but the present disclosure is not limited thereto. The FOV is previously determined according to, for example, a size of the treadmill 100 (e.g., a distance between the console 13 and a user) and the operation space 700. The light sensor 151 acquires an image frame Fm toward an operation space 700, i.e. toward a direction of the user 900. In some aspects, the treadmill 100 further includes a light source illuminating light toward the operation space 700.

In one aspect, the light sensor 151 is arranged on the console 13, and a bottom edge of the FOV is arranged to be substantially parallel to a horizontal line, as shown in FIG. 1. One reason of arranging the FOV above the horizontal line for acquiring the image frame Fm will be described below.

The processor 153 is, for example, a digital signal processor (DSP), an application specific integrated circuit (ASIC), a field programmable gate array (FPGA) or the like without particular limitations. The processor 153 performs face detection 1533 and human detection 1535 on the image frame Fm received from the light sensor 151, and identifies whether the operation space 700 is occupied by any user according to detection results of the face detection 1533 and the human detection 1535 using software, firmware and/or hardware. In FIG. 3, the face detection 1533 and the human detection 1535 indicate different algorithms respectively embedded in the processor 153.

The face detection algorithm 1533 of the processor 153 determines a face region ROI_f in the image frame Fm, referring to FIGS. 1 and 2. The human detection algorithm 1535 of the processor 153 determines a human region ROI_b in the image frame Fm, referring to FIGS. 1 and 2. The face detection algorithm 1533 and the human detection algorithm 1535 can utilize those algorithms known to the art without particular limitations as long as the processor 153 can utilize said algorithms to respectively determine a face region ROI_f and a human region ROI_b, and to identify whether the operation space 700 (or the base 11) is occupied by a user or not.

In the present disclosure, when the processor 153 identifies that the operation space 700 (or the base 11) is suddenly not occupied by any user during the tread belt 110 being operating (i.e. motor 17 running), it means that a user fall condition may occur. In this case, the processor 153 stops running of the tread belt 110 (i.e. motor 17 being stopped) and raises an alarm, which includes giving a warning sound or sending a message to a portable device or a central control system without particular limitations.

In one aspect, when the image frame Fm does not contain a face region ROI_f or a human region ROI_b, the processor 153 identifies that the operation space 700 (or the base 11) is not occupied by any user.

In one aspect, when the face region ROI_f is not within the human region ROI_b (e.g., the face region ROI_f outside the human region ROI_b), and a height of the human region ROI_b is smaller than a half of the FOV (or a half of a height of the image frame Fm), the processor 153 identifies that the operation space 700 (or the base 11) is not occupied by any user. This arrangement is used to identify a user 800 behind the treadmill 100 as an invalid user, which has a human region shown as ROI_b2 in FIG. 1.

In a further aspect, when a shift of the human region ROI_b from a longitudinal center line of the image frame Fm (or the base 11) is larger than or equal to a predetermined distance, the processor 153 identifies that the operation space 700 (or the base 11) is not occupied by any user. The predetermined distance is determined, for example, according to a width of the base 11 without particular limitations. This arrangement is used to identify the user(s) at two sides of the treadmill 100 (not shown) as an invalid user.

In an alternative aspect, when a bottom edge of the human region ROI_b is not aligned with a bottom edge of the image frame Fm, the processor 153 identifies that the operation space 700 (or the base 11) is not occupied by any user. As mentioned above, because the bottom edge of the FOV is arranged to be parallel to the horizontal line, bottom edges of the human region ROI_b and the image frame Fs are aligned with each other if a user is on the base 11. This arrangement is to identify human images in the poster and screen which are close to the treadmill 100 as invalid users.

In a further alternative aspect, when a width of the human region ROI_b or the face region ROI_f is smaller than a predetermined width (e.g., determined according to actual measurements), the processor 153 identifies that the operation space 700 (or the base 11) is not occupied by any user. This arrangement is also used to identify human images in the poster and screen which are close to the treadmill 100 as invalid users.

In the present disclosure, the invalid user does not wake up the treadmill 100 and is not used in the occupancy detection.

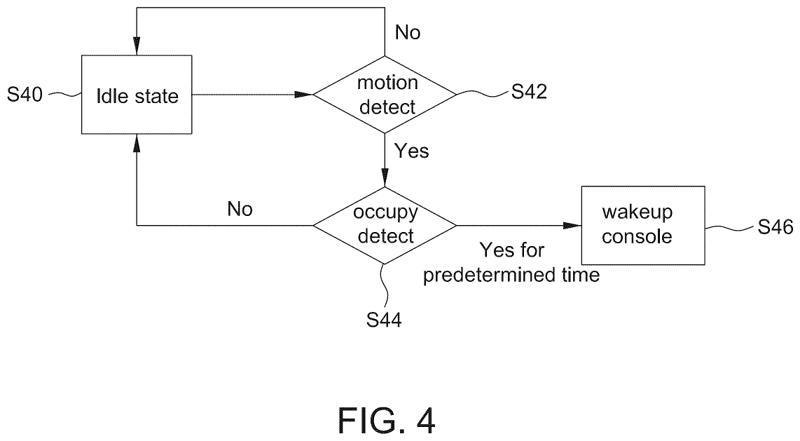

Please refer to FIG. 4, it is a flow chart of an auto-wakeup method of a treadmill 100 according to one embodiment of the present disclosure. The wakeup method includes the steps of: entering an idle state (Step S40); performing motion detection using an optical sensing chip (Step S42); upon a motion being detected, performing occupancy detection of a base using the optical sensing chip (Step S44); and upon identifying that the base being occupied, waking up a console (Step S46). As shown in FIG. 3, the optical sensing chip 15 includes a light sensor 151 and a processor 153.

Step S40: In the present disclosure, an idle state is referred to that the treadmill 100 is not operated by any user for a predetermined time interval, e.g., no user entering the operation space 700 (e.g., standing on the base 11) and the console 13 not being operated. In the idle state, the console 13 is turned off and the base 11 is not running, e.g., the motor 17 not driving the tread belt 110. However, in the idle state, the optical sensing chip 15 continuously performs the detection at a predetermined frequency.

Step S42: In the idle state, the optical sensing chip 15 performs motion detection 1531 using the image frame Fm captured by the light sensor 151, i.e. using a motion detection algorithm to calculate whether the image frame Fm includes a motion, which is identified according to two sequentially captured image frames Fm (e.g., using correlation) or is directly identified using a pixel circuit of the light sensor 151. The method of detecting a motion using a pixel circuit may be referred to U.S. patent application Ser. No. 17/009,417, entitled “PIXEL CIRCUIT OUTPUTTING PULSE WIDTH SIGNALS AND PERFORMING ANALOG OPERATION” filed on Sep. 1, 2020, assigned to the same assignee of the present application, and the full disclosure of which is incorporated herein by reference, and thus details thereof are not described herein.

When there is no motion being detected, the Step S42 is continuously executed under the idle state, but the optical sensing chip 15 does not perform the occupancy detection of the base 11, i.e. the face detection algorithm 1533 and the human detection algorithm 1535 not being executed. If the motion is detected, the Step S44 is entered.

Step S44: Whether the operation space 700 of the treadmill 100 is occupied or not is identified according to the face region ROI_f and the human region ROI_b as mentioned in the above, and thus details thereof are not repeated herein. Upon identifying that the operation space 700 is not occupied by any user, it means that the motion detected in the Step S42 does not occur in the operation space 700, and the Step S40 is returned to keep the idle state. In this way, it is able to prevent the treadmill 100 being accidentally woken up by a person adjacent to the treadmill 100. On the other hand, while identifying that the operation space 700 is occupied by a user for a predetermined time interval (e.g., exceeding 3 seconds, but not limited to), the Step S46 is entered.

Step S46: When the console 13 is woken up (e.g., by a signal So), e.g., activating the screen thereof, the user may set the speed and tilted angle of the base 11 through the console 13, and may start the motor 17 to drive the tread belt 110. The method of how the motor 17 drives the tread belt 110 to move is known to the art and not a main objective of the present disclosure, and thus details thereof are not described herein.

In this aspect, the treadmill 100 may detect the status (e.g., including the height and pressure) of the tread belt 110 using other sensors as an auxiliary judgment of whether a user is standing on the base 11.

Accordingly, when a user standing on the base 11 exceeding a predetermined time interval, the console 13 is automatically turned on, i.e. waiting being operated.

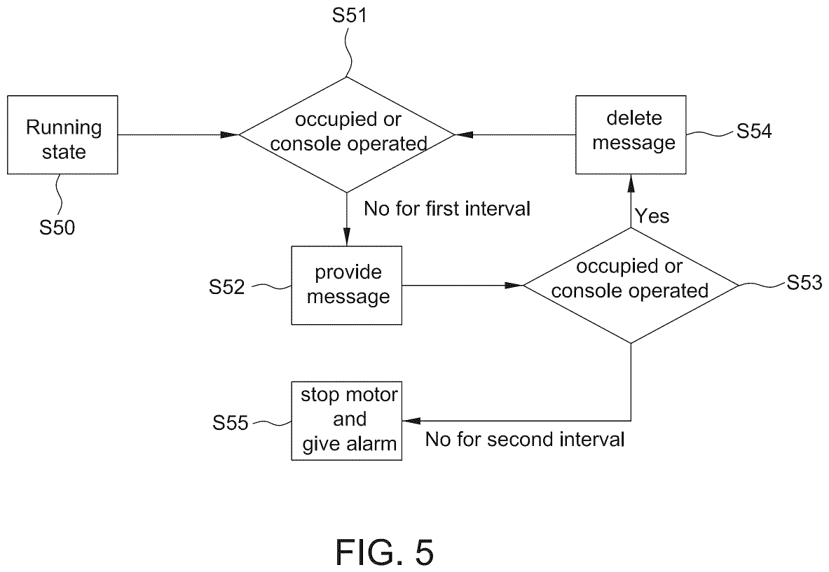

Please refer to FIG. 5, it is a flow chart of a fall detection method of a treadmill 100 according to one embodiment of the present disclosure. The fall detection method includes the steps of: entering an operating state (Step S50); performing occupancy detection of a base using an optical sensing chip or identifying whether the console is operated (Step S51); upon identifying that the base is not occupied for a first time interval using the optical sensing chip, controlling a console to raise a confirm message (Step S52); after the confirm message being raised, identifying whether the base is occupied by a user using the optical sensing chip or whether the console is operated (Step S53); upon the confirm message being cancelled, returning to the Step S51 (Step S54); and upon identifying that the confirm message not being cancelled for a second time interval, leaving the operating state and raising an alarm (Step S55). As shown in FIG. 3, the optical sensing chip 15 includes a light sensor 151 and a processor 153.

Step S50: In the present disclosure, an operating state (or called running state) is referred to that the motor 17 is driving the tread belt 110 to move at a selected speed. Generally, a user 900 is walking or running on the base 11 in the operating state.

Step S51: In the operating state, the optical sensing chip 15 (or a processor, e.g., MCU or CPU, of the console 13) continuously performs occupancy detection and/or confirms whether the console 13 is operated, e.g., touching a screen thereon, pressing a key, switching a switch or the like. The occupancy detection is performed according to the method mentioned above, and thus details thereof are not repeated herein.

When the optical sensing chip 15 confirms that the treadmill 100 is not operated (including no user occupying the operation space 700 or operating the console 13) exceeding (i.e. longer than or equal to) a first time interval, a confirm message is raised (e.g., using a signal So) to allow the user to respond whether the treadmill 100 is continuously used. The confirm message is given by, for example, showing on the screen or playing a warning sound without particular limitations.

Step S53: After the confirm message being raised, the optical sensing chip 15 continuously performs the occupancy detection and/or confirms whether the console 13 is operated. When the optical sensing chip 15 identifies that the base 11 is occupied or the console 13 is operated by a user within a second time interval, it means that the user will continuously use the treadmill 100. The second time interval is identical to or different from the first time interval. Furthermore, in order to allow the treadmill 100 to respond quickly, the first time interval and the second time interval are not selected too long, e.g., shorter than 5 seconds.

Step S54: When identifying, within the second time interval, that the base 11 is occupied or the console 13 is operated by a user, the optical sensing chip 15 stops raising the confirm message (e.g., using the signal So), e.g., removing the message from the screen or stopping the warning sound. The method of stopping the confirm message is determined according to the way that the confirm message is raised.

Step S55: When identifying, within the second time interval, that the base 11 is not occupied or the console 13 is not operated by a user, it means that a fall condition may occur. In this scenario, the optical sensing chip 15 controls (e.g., sending the signal Sc via the console 13) the motor 17 to stop driving the tread belt 110 and to raise a fall alarm. Preferably, the fall alarm is a sound to warn neighboring people to notice the fall, or the fall alarm is wirelessly sent to a portable device or a central control system to notice staffs on the spot. The method of raising the fall alarm is not particularly limited as long as neighboring people can be warned.

In the present disclosure, the embodiment in FIG. 4 is to activate or turn on the treadmill 100 from an idle state, and the embodiment in FIG. 5 is to prohibit the running of the treadmill 100.

In a further aspect, the optical sensing chip 15 further includes a thermosensor for the living body detection. For example, the thermosensor has a field of view substantially identical to that of the light sensor 151. The processor 153 firstly determines a window of interest (WOI) in a thermal image captured by the thermosensor, and then performs the motion detection 1531, the face detection 1533 and the human detection 1535 only according to the pixel image corresponding to the WOI of the thermal image so as to eliminate the interference surrounding the user 900, e.g., interference from the human image on a poster.

In an alternative aspect, the optical sensing chip 15 has the function of identity recognition. For example, the optical sensing chip 15 is further embedded with an identity recognition algorithm for identifying a user's identity according to face features. Therefore, the treadmill 100 further has a memory (including a volatile memory and/or a non-volatile memory) for recording operation setting of every user, e.g., including the moving speed, tilted angle, operating time of the tread belt 110, but not limited to. For example, when the Step S46 of FIG. 4 is entered, the console 13 automatically calls out the operation setting corresponding to a user's identity currently being recognized so as to improve the user experience.

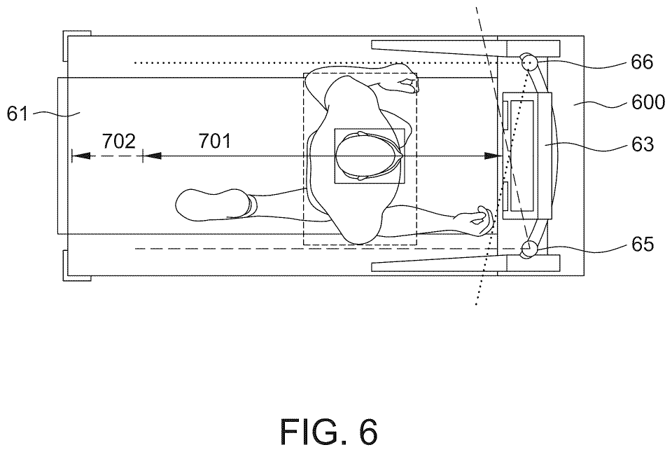

FIG. 6 shows a treadmill 600 according to another embodiment of the present disclosure. The treadmill 600 also includes a base 61 and a console 63, which are respectively identical to the base 11 and the console 13 mentioned above, and thus details thereof are not repeated herein. The difference of the treadmill 600 and the treadmill 100 in the embodiment of FIGS. 1 and 2 is that the treadmill 600 includes two optical sensing chips 65 and 66 for respectively capturing an image frame toward a front of the console 63. In this embodiment, it is able to directly calculate whether a position of user is within a range of the operation space (i.e. the base 61) according to image frames captured by the two optical sensing chips 65 and 66 so as to confirm whether the base 61 is occupied or not.

For example, when the treadmill 600 executes the wakeup method of FIG. 4, in the Step S44 the processor of the optical sensing chip 65 or 66, or the processor of the console 63 (e.g., a micro controller unit or central processing unit) is used to calculate a three-dimensional position of a user according to image frames captured by the optical sensing chip 65 or 66, and identifies whether the calculated position is within the operation space (i.e. 701+702) or not so as to determine whether to enter the Step S46 or S40. The method of calculating the three-dimensional position using two image frames from different FOV is known to the art, and thus details thereof are not described herein.

For example, when the treadmill 600 executes the fall detection method of FIG. 5, in the occupancy detection of Steps S51 and S53, the processor of the optical sensing chip 65 or 66, or the processor of the console 63 is used to calculate a three-dimensional position of a user according to image frames captured by the optical sensing chip 65 or 66, and identifies whether the calculated position is within the operation space (i.e. 701+702) or not so as to identify whether the operation space is occupied or not.

In an alternative aspect, embodiments in FIGS. 1 and 6 are combined to form another embodiment. That is, the treadmill includes three optical sensing chips to prevent a part of the optical sensing chips being blocked by obstacles and unable to capture the user image. For example, when at least one of the optical sensing chips 65 and 66 is blocked by the obstacle, the treadmill operates as the embodiment of FIG. 1; whereas when the optical sensing chip 15 is blocked by the obstacle, the treadmill operates as the embodiment of FIG. 6.

In a further aspect, while identifying (after entering the operating state) that the face region ROI_f and/or the human region ROI_b do not move (e.g., larger than a predetermined distance) for a predetermined time interval (e.g., from 30 seconds to 60 seconds, but not limited to), the processor 153 (or a processor of the console) further determines that a current user is an invalid user, which is used as one kind of living body detection since it is generally not possible that a real user does not have any movement for a long time on the base 11.

In a further alternative aspect, the processor 153 (or a processor of the console) identifies the pace and performance (e.g., may be shown on the console 13 or 63) of running or walking of a user according to a position variation of the face region ROI_f and/or the eye position (e.g., identified while performing the face detection), e.g., identifying according to a variation frequency of up-down positions in the image frame Fm. For example, when the variation frequency becomes slower, it means that a motion speed of the user becomes slower. In addition, the processor 153 (or a processor of the console) further identifies whether a fall occurs according to the position of the face region ROI_f and/or eyes. For example, when the position of the face region ROI_f and/or eyes suddenly moves downward to exceed the bottom edge of the field of view FOV, a fall event is identifies, which may be operated in conjunction with occupancy detection of the base 11 as mentioned above to further improve the detection ability of the treadmill.

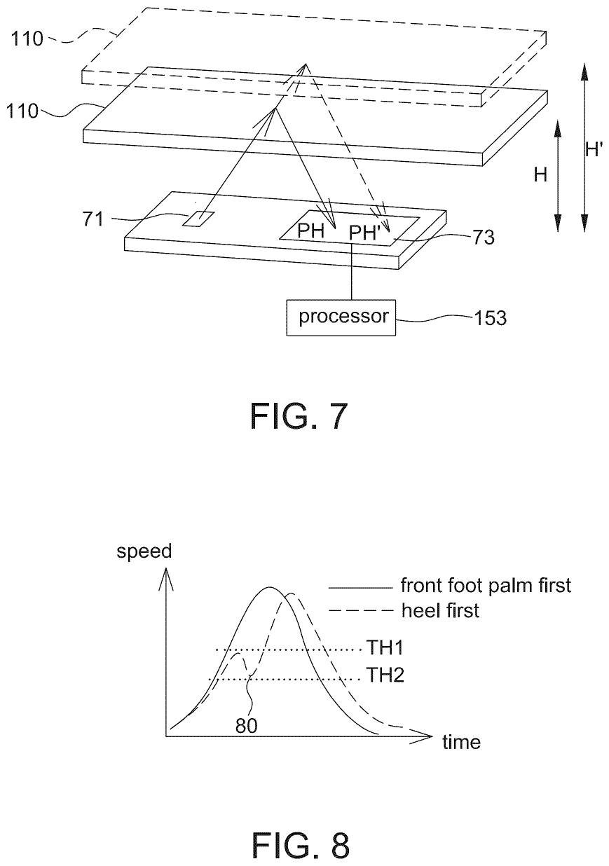

Please refer to FIG. 7, it is a schematic diagram of detecting a user's weight using an optical method by a treadmill (only tread belt 110 being shown herein without showing other components) 100 or 600 according to one embodiment of the present disclosure. FIG. 7 shows that when there is no user standing on the base 11 or 61, the tread belt 110 is at a height H′, whereas when there is a user standing on the base 11 or 61, the tread belt 110 is decreased to a height H.

In this embodiment, the treadmill 100 or 600 further includes a light source 71 (e.g., a laser diode or light emitting diode, but not limited to) and an optical sensing chip (e.g., similar to the optical sensing chip 15 mentioned above including a light sensor and a processor, but not limited to) 73 arranged below the tread belt 110 for detecting a height variation of the tread belt 110, wherein the optical sensing chip 73 preferably has a two-dimensional sensing surface. As shown in FIG. 7, when the tread belt 110 is at the height H′, reflected light of the light source 71 is projected at a first position PH′, whereas when the tread belt 110 is at the height H, the reflected light of the light source 71 is projected at a second position PH. Base on the triangular calculation, the processor 153 calculates a corresponding height according to different light projecting positions.

It should be mentioned that although FIG. 7 shows that the light projecting positions PH′ and PH vary in a length direction of the tread belt 110, the present disclosure is not limited thereto. In other aspects, the light source 71 and the optical sensing chip 73 are arranged along a width direction or other directions of the tread belt 110.

In addition, by previously measuring a relationship of different heights and different user's weights and recording the relationship in a memory, the processor 153 (or a processor of the console) calculates a corresponding user's weight according to a height of the tread belt 110 corresponding to a light projecting position.

In one aspect, the processor 153 (or a processor of the console) controls output of the motor 17 according to different user's weights so as to keep the tread belt 100 to move at a fixed speed. For example, when the user's weight is higher, the motor 17 is controlled to have a higher output, which is controlled by previously setting and recording the relationship between the user's weight and motor output in the memory. In this way, no matter what the user's weight is, the tread belt 110 reflects a correct operating speed desired by the user.

In another aspect, when the user 900 is running or walking on the base 11, the height of the tread belt 110 has a regular variation corresponding to a step frequency of the user 900. Accordingly, the processor 153 (or a processor of the console) further calculates the user's step frequency according to a frequency of the height variation. For example, a time interval between two dips of the tread belt 110 indicates a time interval of one step of user. The processor 153 further controls the console to show the step frequency.

In a further aspect, the processor 153 (or a processor of the console) further calculates a moving speed of the tread belt 110 according to image frames acquired by the optical sensing chip 73, e.g., using correlation, but not limited to. However, when a height of the tread belt 110 is changed, the speed calculated by the processor 153 is also changed. Therefore, the processor 153 (or a processor of the console) further calibrates a moving speed of the tread belt 110 calculated using the image frames according to the height of the tread belt 110. The speed calibrations corresponding to different heights f the tread belt 110 are previously measured and recorded in the memory for being accessed by the processor 153 so as to obtain correct calculated speed.

It should be mentioned that although FIG. 7 shows that the light source 71 and the optical sensing chip 73 are arranged at the same base, the present disclosure is not limited thereto. In another aspect, the light source 71 and the optical sensing chip 73 are two separated components.

It is noticed that when a user is walking or running on the tread belt 110 in operation, a moving speed of the tread belt 110 is affected and changed by a force of each user's step stepping on the tread belt 110. The present disclosure further provides a treadmill capable of analyzing exercise (e.g., including walking and/or running) performance of a current user on the tread belt 110.

Please refer to FIG. 1 again, the treadmill 100 or 600 of the present disclosure further includes another optical sensing chip 75 for detecting the moving speed of the tread belt 110, e.g., by calculating correlation between image frames using a processor thereof, but not limited to calculating the moving speed by correlation. The optical sensing chip 75 is identical to the optical sensing chip 15 as mentioned above, e.g., including a light sensor and a processor, which have been illustrated above, and thus details thereof are not repeated herein.

Please refer to FIG. 8, it is a schematic diagram of a variation of a belt speed of one step corresponding to different running postures of a user on a treadmill 100 or 600 according to one embodiment of the present disclosure. FIG. 8 shows that if a user puts his/her heel on the tread belt 110 at first and then puts his/her front foot palm on the tread belt 110 when he/she is running on the tread belt 110, the moving speed of the tread belt 110 appears a deep 80 (not monotonically increasing) within an increasing interval (i.e. an interval during which the foot on the tread belt 110 moves from front to back), and the deep 80 is lower when the user gives more force to the tread belt 110 through his/her heel. In continuous running, the variation shape shown in FIG. 8 repeatedly appears corresponding to every step, reflecting running postures of the user. On the other hand, if the user puts his/her front foot palm on the tread belt 110 at first when he/she is running on the tread belt 110, the moving speed of the tread belt 110 does not have a deep 80, i.e. continuously increasing to the top as shown in FIG. 8. By this variation shape, it is able to distinguish the posture of a user in running.

It is known that running with the heel touching the ground at first can cause injury and have poor exercise performance. Therefore, in the present disclosure, the optical sensing chip 75 identifies the deep 80 in the variation of moving speed of the tread belt 110, and informs (by sending a signal) the console 13 or 63 to show the calculated exercise performance on the screen thereof.

For example, a processor of the optical sensing chip 75 or of the console 13 or 63 compares a position of the deep 80 with predetermined thresholds to determine the exercise performance. For example, the processor (or memory of the treadmill 100 or 600) is embedded with two thresholds (e.g., TH1 and TH2 shown in FIG. 8) each determining a separation of one exercise performance to be shown on the console 13 or 63, e.g., including poor performance (e.g., lower than TH2), middle performance (e.g., between TH1 and TH2) and high performance (e.g., higher than TH1). In another aspect, the exercise performance is indicated by a light source with different light colors (e.g., green, yellow and red, but not limited to) or given by voice signals without particular limitations.

It should be mentioned that the optical sensing chip 75 is not limited to be arranged adjacent to the tread belt 110 as shown in FIG. 1. In another aspect, the optical sensor chip 73 shown in FIG. 7 is also used to detect the moving speed of the tread belt 110, and thus in this case the treadmill 100 or 600 does not have the optical sensor chip 75. The optical sensor chip for detecting the moving speed of the tread belt 110 is not limited to be arranged at the position as 73 or 75 but at other positions capable of capturing images of the tread belt 110 or images of a bearing of the tread belt 110.

In the present disclosure, the moving speed of the tread belt 110 is not limited to be detected by an optical means but by a mechanical means as long as the detected result (e.g., row data or speed) is sent to the processor of the console 13 or 63. The processor of the console 13 or 63 then identifies the deep 80 in the variation of moving speed (as shown in FIG. 8) and compares a depth of the deep 80 with predetermined thresholds to determine the exercise performance to be shown thereon or given by other means.

The console 13 or 63 is arranged to show values or status of exercise performance or directly show the calculated moving speed as shown in FIG. 8.

It should be mentioned that although the above embodiments are illustrated by using a treadmill, the present disclosure is not limited thereto. The wakeup method and the fall detection method of the present disclosure are also adaptable to other equipment with driving power, e.g., rehabilitation equipment, without particularly limitations.

As mentioned above, the sports equipment having driving power is required to detect the operating status of a user during the running state such that it is able to find uncomfortable user immediately and giving an alarm. Accordingly, the present disclosure provides a treadmill (e.g., as shown in FIGS. 1 to 2) that can be woken up in an idle state according to the occupancy of an operation space, and can perform the fall detection in a running state according to the occupancy of an operation space so as to real-timely give a warning when the user has a fall condition thereby improving the safety of the sports equipment.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A treadmill, comprising:
a base, configured to determine an operation space of the treadmill;
a console, configured to show operating information of the treadmill;
a light sensor, configured to acquire an image frame toward the operation space using a field of view; and
a processor, configured to
perform face detection and human detection on the image frame, and
identify whether the operation space is occupied by any user according to detection results of the face detection and the human detection.

2. The treadmill as claimed in claim 1, wherein
the light sensor is arranged on the console, and
a bottom edge of the field of view of the light sensor is arranged to be parallel to a horizontal line.

3. The treadmill as claimed in claim 1, wherein
the treadmill further comprises another light sensor arranged below a tread belt of the base and configured to detect a height variation of the tread belt, and
the processor is further configured to calculate at least one of a step frequency and a weight of a user.

4. The treadmill as claimed in claim 1, wherein the processor is configured to
determine a face region in the image frame using a face detection algorithm,
determine a human region in the image frame using a human detection algorithm, and
identify whether the operation space is occupied by any user according to the face region and the human region in the image frame.

5. The treadmill as claimed in claim 4, wherein upon the face region is not within the human region and a height of the human region is smaller than a half of the field of view, the processor is configured to identify that the operation space is not occupied by any user.

6. The treadmill as claimed in claim 4, wherein upon a shift of the human region from a center line of the image frame being larger than or equal to a predetermined distance, the processor is configured to identify that the operation space is not occupied by any user.

7. The treadmill as claimed in claim 4, wherein upon a bottom edge of the human region is not aligned with a bottom edge of the image frame, the processor is configured to identify that the operation space is not occupied by any user.

8. The treadmill as claimed in claim 4, wherein upon a width of the human region being smaller than a predetermined width, the processor is configured to identify that the operation space is not occupied by any user.

9. The treadmill as claimed in claim 1, wherein upon identifying that the operation space is not occupied by any user during a tread belt of the base being running, the processor is configured to stop the tread belt and raise an alarm.

10. The treadmill as claimed in claim 1, wherein
the treadmill further comprises another light sensor configured to detect a moving speed of the tread belt, and
the processor is further configured to determine exercise performance of a current user according to a variation of the moving speed.

11. A wakeup method of a treadmill, the treadmill comprising a console, a base and an optical sensing chip, the wakeup method comprising:
entering an idle state;
performing motion detection using the optical sensing chip;
upon a motion being detected, performing occupancy detection of the base using the optical sensing chip; and
upon detecting that the base is occupied by a user, waking up the console.

12. The wakeup method as claimed in claim 11, wherein in the idle state, the console is turned off and a tread belt of the base stops running and the wakeup method further comprises:
upon no motion being detected, not performing the occupancy detection of the base using the optical sensing chip.

13. The wakeup method as claimed in claim 11, wherein
the optical sensing chip is arranged on the console, and
the optical sensing chip comprises a light sensor for acquiring an image frame toward a front of the console, and a bottom edge of a field of view of the light sensor is parallel to a horizontal line.

14. The wakeup method as claimed in claim 13, further comprising:
using the optical sensor chip to
determine a face region in the image frame using a face detection algorithm,
determine a human region in the image frame using a human detection algorithm, and
perform the occupancy detection according to the face region and the human region in the image frame.

15. The wakeup method as claimed in claim 14, wherein the optical sensing chip identifies that the base is not occupied by a user upon at least one of following conditions being true,
the image frame not containing the face region and the human region,
the face region not within the human region, and a height of the human region being smaller than a half of the field of view,
a shift of the human region from a center line of the image frame being larger than or equal to a predetermined distance,
a bottom edge of the human region not aligned with a bottom edge of the image frame, and
a width of the human region being smaller than a predetermined width.

16. A fall detection method of a treadmill, the treadmill comprising a console, a base and an optical sensing chip, the fall detection method comprising:
entering an operating state and performing occupancy detection of the base using the optical sensing chip;
upon the base not being occupied by any user for a first time interval, controlling the console to raise a confirm message by the optical sensing chip; and
upon the confirm message not being cancelled for a second time interval, leaving the operating state and raising an alarm.

17. The fall detection method as claimed in claim 16, wherein the confirm message is cancelled by at least one of,
identifying, using the optical sensing chip, that the base is occupied by a user within the second time interval, and
the console being operated by the user.

18. The fall detection method as claimed in claim 16, wherein
the optical sensing chip is arranged on the console, and
the optical sensing chip comprises a light sensor for acquiring an image frame toward a front of the console, and a bottom edge of a field of view of the light sensor is parallel to a horizontal line.

19. The fall detection method as claimed in claim 18, further comprising:
using the optical sensor chip to
determine a face region in the image frame using a face detection algorithm,
determine a human region in the image frame using a human detection algorithm, and
perform the occupancy detection according to the face region and the human region in the image frame.

20. The fall detection method as claimed in claim 19, wherein the optical sensing chip identifies that the base is not occupied by a user upon at least one of following conditions being true,
the image frame not containing the face region and the human region,
the face region not within the human region, and a height of the human region being smaller than a half of the field of view,
a shift of the human region from a center line of the image frame being larger than or equal to a predetermined distance,
a bottom edge of the human region not aligned with a bottom edge of the image frame, and
a width of the human region being smaller than a predetermined width.
